(19) United States
(12) Patent Application Publication
(10) Pub. No.: US 2010/0316441 A1
(43) Pub. Date: Dec. 16, 2010

(54) JOINING DEVICE AND SYSTEM FOR A RIGID CONNECTION BETWEEN MAGNETICALLY ANCHORABLE BAR-SHAPED ELEMENTS

(76) Inventor: Claudio Vicentelli, Sassari (IT)

Correspondence Address: YOUNG & THOMPSON, 209 Madison Street, Suite 500, Alexandria, VA, 22314, US

(21) Appl. No.: 12/521,720

(22) PCT Filed: Dec. 20, 2007
(86) PCT No.: PCT/EP07/11245

§ 371 Date: Jun. 29, 2009

(30) Foreign Application Priority Data
Dec. 27, 2006 (IT) MI2006A002512

(51) Int. Cl. F16B 7/14; F16B 7/16; F16B 7/00

(52) U.S. Cl. 403/300; 403/376; 403/382

(57) ABSTRACT

A joining device for structural magnetic assemblies including elongated modular elements (10) magnetically anchorable to one another and/or to intermediate modular elements (11); the joining device (13) includes at least a first and a second connecting member (14) interconnected by an intermediate link member (15); each connecting member (14), has a hollow body open at both ends, provided with an inner mating surface conforming to an outer mating surface of the elongated modular elements (10). Anti-rotational retaining element (21; 22; 27) are provided at an end (18) of each connecting member (14) to engage corresponding retaining element (21; 22; 27) of a connecting member (14) of another joining device (13) threaded onto a same elongated modular element (10), to hold a fixed relationship.

### BACKGROUND OF THE INVENTION

This invention refers to certain improvements to structural assemblies of the type comprising magnetically anchorable modular elements, for example in the form of elongated or bar-shaped elements magnetically anchorable to one another or to intermediate modular elements, suitable for the construction of stable reticulated structures for game assemblies, or for other technical use.

In particular the invention is directed to a joining device conformed for allowing a rigid connection between magnetically anchorable modular elements, preventing pivotal and/or rotational movements of the modular elements according to one or more rotational axes in the construction of an assembly.

The invention is also directed to a joining system comprising a plurality of magnetically anchorable modular elements for the construction of stable structures, in combination with a joining device capable of preventing relative angular and/or rotational movements between the same modular elements of the assembly and to allow at the same time the magnetic anchorage of the modular elements and the construction of a stable grid structure, regardless of the lesser or greater complexity of the same assembly.

### STATE OF THE ART

Magnetic assemblies for the construction of reticulated or grid structures comprising elongated modular elements, magnetically anchorable to one another and/or to intermediate modular elements, are widely known for example from DE-A-39 10 304, U.S. Pat. No. 2,970,388 and EP-A-1.080.476.

These documents show magnetic assemblies and/or reticulated structures suitable for games, teaching purposes, or for other technical applications, in which use is made of two different types of modular elements, in particular a first type of elongated magnetically active module, for example in the form of a bar, and a second type of intermediate connecting module suitably conformed for allowing the magnetic anchorage of several bars in different angular dispositions.

The bars or the elongated and magnetically active modular elements can be made in any way whatsoever; for example, they can consist of a single elongated permanent magnet, or can comprise at least one magnet and at least one ferromagnetic element axially aligned and magnetically in contact with each other at their ends to form polar anchoring surfaces of opposite polarities at the distal ends. The elongated modular elements can also be made differently, for example they can comprise two permanent magnets secured to the ends of a tubular element of plastic material or of a magnetically non-conductive spacer piece.

The intermediate connecting elements in turn are made either of ferromagnetic material, or comprise one or more magnets, or a combination thereof, and can be of any geometrical shape suitable for the intended use, for example a sphere or ball-shaped element, or delimited by flat side surfaces.

Modular elements of the aforementioned kind allow the construction of structural and/or reticulated assemblies having simple or complex geometrical shapes, with extremely variable dimensions; they also allow to achieve more or less considerable magnetic anchoring forces, depending on to the magnetic characteristics of the individual modular elements, and on the involved magnetic circuits.

In the case of assemblies of considerable dimensions and/or with cantilever parts, one typical problem concerns the static and shape stability of the structure itself, due to possible relative pivotal and/or rotational movements between the modules of an assembly, that the magnetic anchoring forces alone are not capable of preventing.

In order to partially obviate this problem, in an attempt to provide a greater stability to an assembly, EP-A-1.349.626 suggests the use of stabilisation elements in the form of panels which can be removably fitted into corresponding polygonal areas circumscribed by the modular elements performing the assembly.

Although the use of stabilisation panels according to EP-A-1.349.626 has allowed the structure to achieve a greater stability, the use of panels nevertheless limits the structural possibilities of an assembly; moreover, each panel is capable of preventing angular movements along two axes only, that is between modular elements which lie in a same main plane.

In turn, EP-A-1.370.334, suggests the use of appropriately shaped connecting elements, which prevent pivotal or angular movements between elongated modular elements magnetically anchored to a same corner or junction knot of a reticulated structure; a solution of this kind consequently does not prevent modular elements belonging to different meshes of the reticulated structure, from moving or rotating in relation to one another.

Although a joining element of this kind contributed to provide a greater degree of stability, it nevertheless still does not provide an absolute stability and rigidity of an entire assembly, or part thereof; in fact, rotational movements of the modular elements, converging towards a junction knot between them or with respect to modular elements which converge towards adjacent junction knots, are still possible and may not be prevented.

### OBJECTS OF THE INVENTION

The main object of this invention is to provide a joining device for rigid connection of magnetically anchorable elongated modular elements, in the construction of structural magnetic assemblies suitable for games or for other applications, which is capable of solving the problems inherent the joining systems previously known.

In particular, an object of the invention is to provide a joining device of angular and/or linear type, for the uses mentioned above, which is capable of providing a high pivotal and/or rotational degree of rigidity and stability, both for simple as well as complex structural assemblies, by an extremely versatile solution capable of allowing ample freedom of connection and orientation between modular elements of a same assembly.

A still further object is to provide a joining device whereby it makes possible to change the angular orientation of the modular elements which converge towards a same junction knot or corner of a grid structure, in relation to different conditions or requirements of use.

A still further object of the invention is to provide a joining system for an assembly of magnetically anchorable modular elements, comprising a plurality of angular and/or linear joining devices appropriately conformed to interengage each other, preventing any angular and/or rotational movement both between modular elements magnetically anchored to and converging towards a same junction knot, or an intermediate connecting element, and between modular elements anchored to different junction knots.

### BRIEF DESCRIPTION OF THE INVENTION

According to a first embodiment of the invention, a joining device has been provided, suitable for a rigid connection between bar-shaped modular elements having an outer mating surface, in which the bar-shaped elements are magnetically anchorable each other to construct an assembly, the joining device comprising:

at least a first and a second connecting member;

an intermediate linking member between the connecting members;

each connecting member having a hollow body defining an open passage for a bar-shaped element, said hollow body having an inner mating surface which conforms to the outer mating surface of the bar-shaped elements, and extends between opposite open ends;

wherein the hollow body of each of said connecting member is provided, at one end, with antirotational retaining means comprising axially extending and angularly spaced apart retaining members, engageable with retaining members of an axially aligned connecting member of another joining device, both threaded on a same bar-shaped element to prevent rotational movements between them.

According to a further embodiment of the invention, a joining system for a rigid connection between magnetically anchorable modular elements suitably for the construction of an assembly, comprising elongated modular elements having an outer mating surface, and joining devices to prevent pivotal and/or rotational movements between them, in which the joining system comprises:

at least a first and a second joining device each provided with at least a first and a second connecting member, and an intermediate linking member;

each connecting member having an hollow body defining an open passage therethrough for an elongated modular element, said hollow body having an inner mating surface which conforms to the outer mating surface of the elongated modular elements, and extends between opposite open ends;

wherein the hollow body of each connecting member of each joining device is provided at one end with antirotational retaining means comprising axially extending and angularly spaced apart retaining members engageable with retaining members pertaining to a connecting member of another joining device both threaded on a same elongated modular member.

According to another embodiment of the invention, a magnetic assembly has been provided, comprising:

a first set of bar-shaped modular elements, each having an external mating surface;

a second set of intermediate modular elements magnetically anchorable to the bar-shaped modular elements; and

a third set of joining devices, said joining devices being conformed and arrangeable each other to prevent angular and/or rotational movements between them and the bar-shaped modular elements of the assembly;

wherein each joining device is provided with at least a first and a second connecting member having an hollow body provided with axially extending retaining means at one end; and

wherein the bar-shaped elements and the connecting members of the joining devices are conformed so that when each bar-shaped element is inserted into the hollow body of respective first and second connecting members of side by side arranged joining devices, each of said bar-shaped element is held in magnetic contact with an intermediate modular element, and the retaining means of the first connecting member, axially engage the retaining means of the second connecting member, to hold the bar-shaped elements of the assembly in a fixed relationship.

These and further features and advantages of the joining device and joining system according to the invention, will be more clearly evident from the following description, with reference to the examples of the drawings, in which:

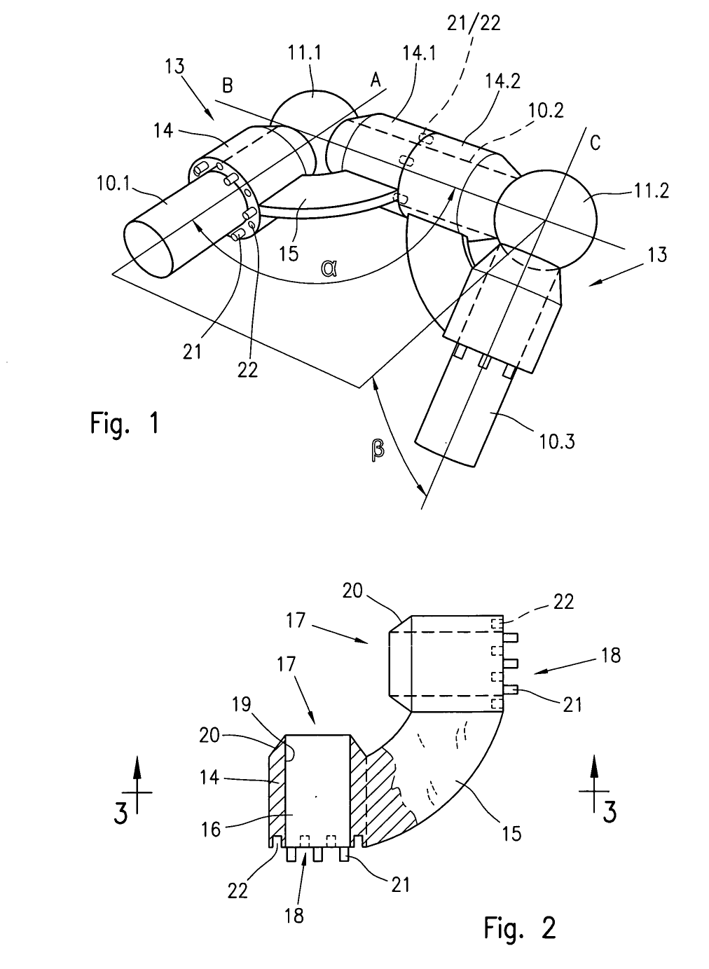

FIG. 1 shows a perspective view of an assembly, showing a first embodiment of joining system comprising two joining devices according to the invention;

FIG. 2 shows a partial cutaway view of one of the joining devices of FIG. 1;

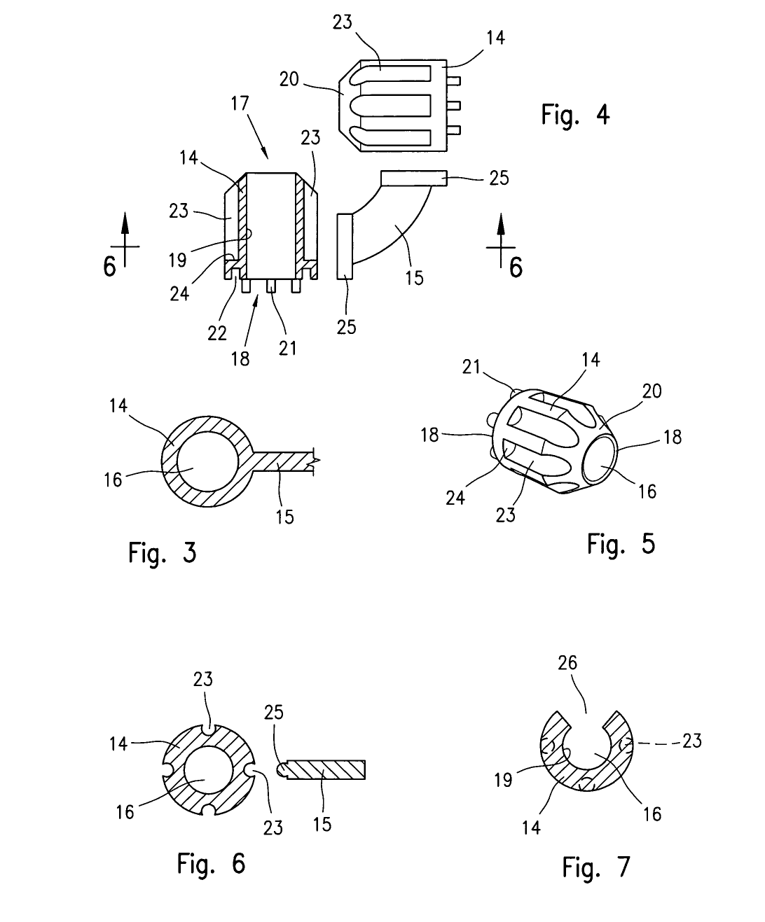

FIG. 3 shows a cross-sectional view along the line 3-3 of FIG. 2;

FIG. 4 shows an exploded, partial cutaway view of a second embodiment of a joining device according to the invention;

FIG. 5 shows a perspective view of one of a connecting member of the joining device of FIG. 4;

FIG. 6 shows a cross-sectional view along the line 6-6 of FIG. 4;

FIG. 7 shows a cross-sectional view similar to that of FIG. 3 or 6, for a different embodiment of the connecting member;

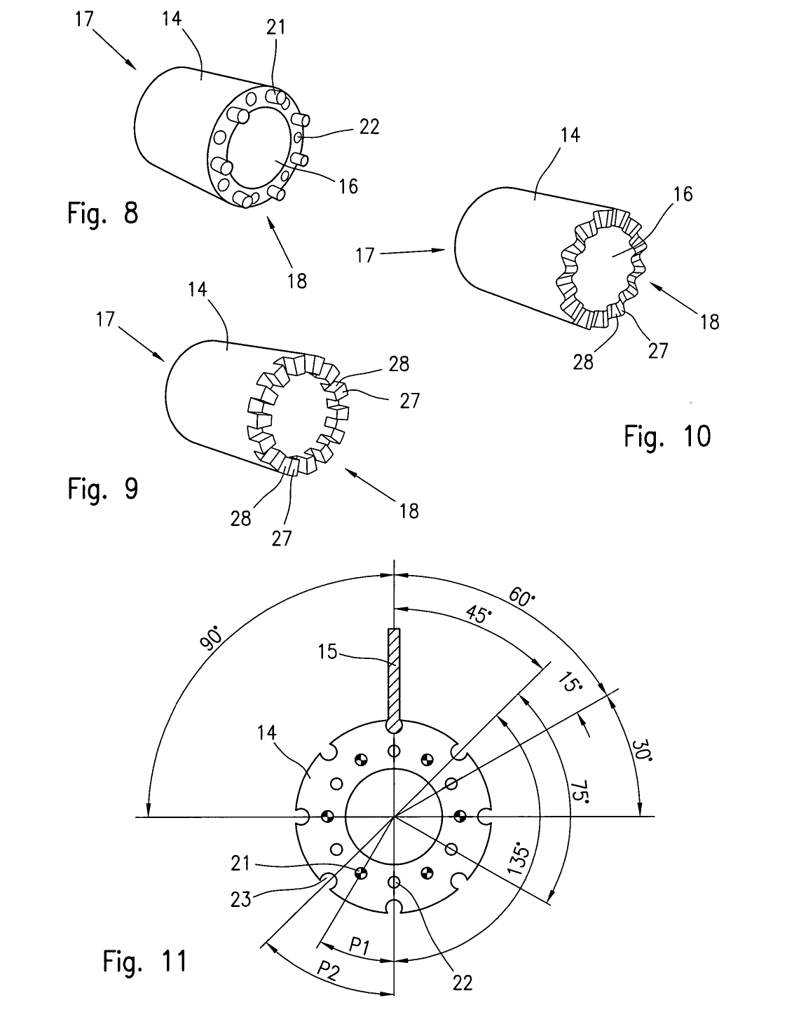

FIG. 8 shows a connecting member, provided with a first embodiment for the anti-rotational retaining means;

FIG. 9 shows a connecting member provided with a second embodiment for the anti-rotational retaining means;

FIG. 10 shows a connecting member provided with a third embodiment for the anti-rotational retaining means;

FIG. 11 is a diagram showing different angular connecting positions, made possible by a connecting member provided with a double retaining system according to the example of FIG. 4;

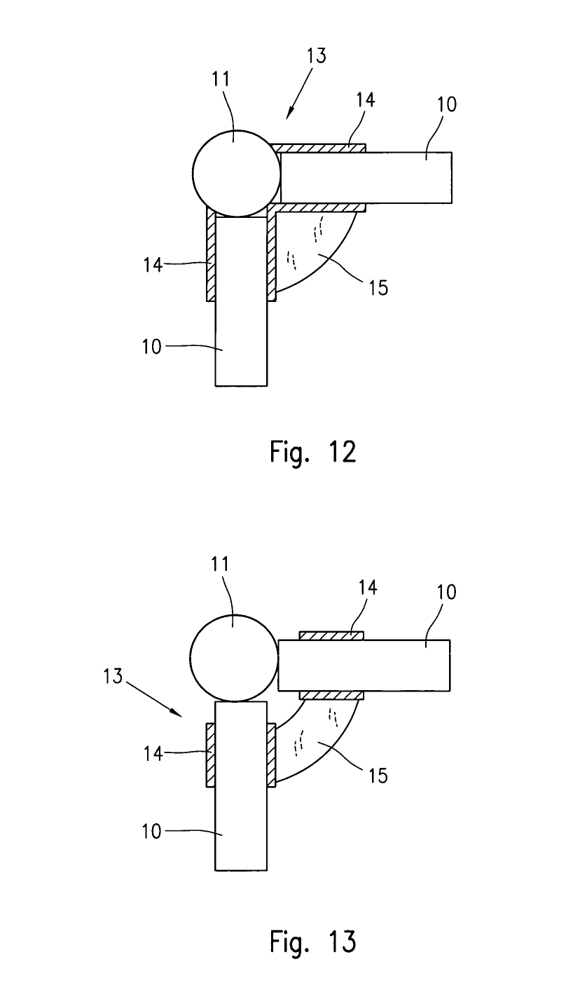

FIG. 12 schematically shows a possible disposition of an angular joining device, with respect to two elongated modular elements magnetically anchored to an intermediate modular element;

FIG. 13 schematically shows a different disposition of an angular joining device, with respect to that of FIG. 12;

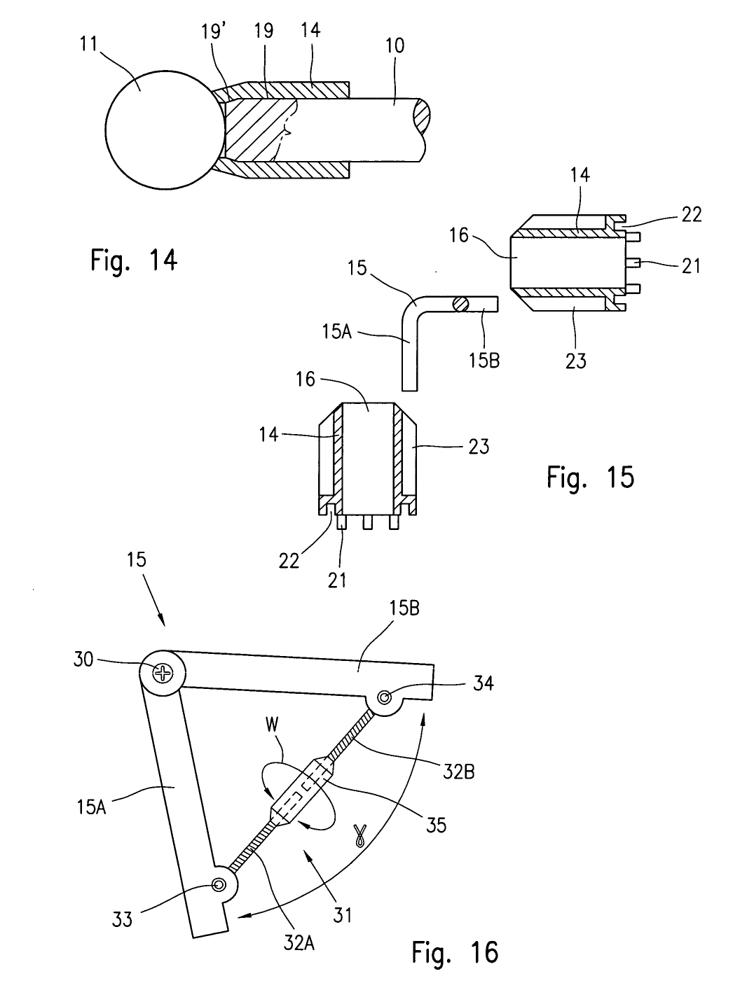

FIG. 14 is a cross-sectional view of an elongated modular element magnetically anchored to an intermediate modular element, and a connecting member of a joining device;

FIG. 15 shows an exploded view of a further embodiment of an angular joining device according to the invention;

FIG. 16 shows an angularly adjustable linking element for the connecting members of a joining device;

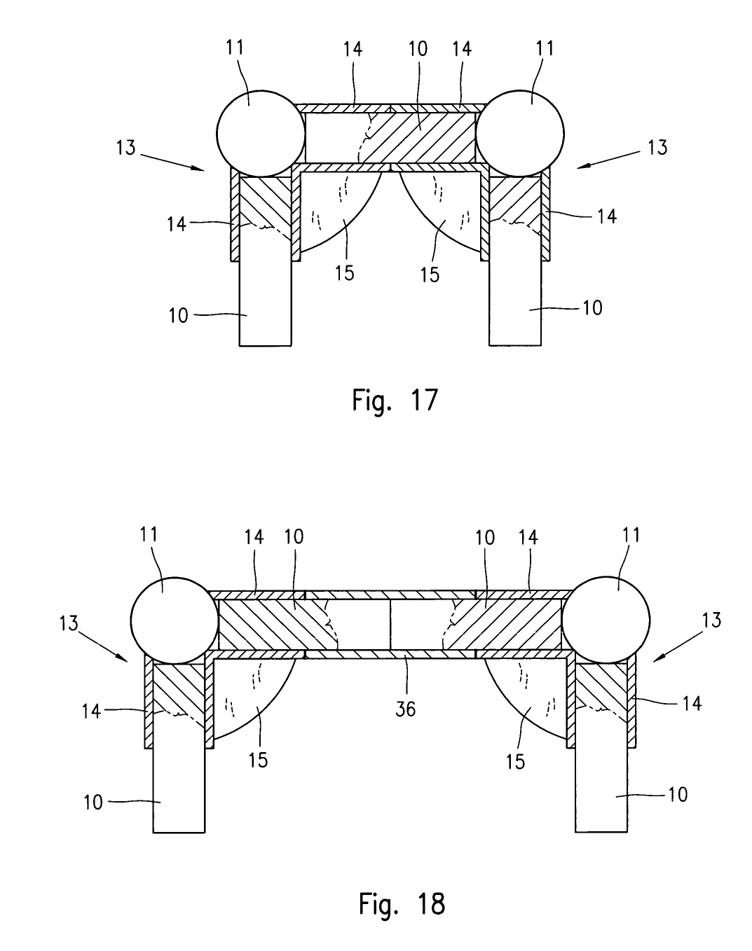

FIG. 17 schematically shows an assembly similar to that of FIG. 1, in which the connecting members of two joining devices are directly engaged with each other;

FIG. 18 schematically shows an assembly similar to that of the previous FIG. 17, in which the connecting elements of two joining devices are engaged by an intermediate connector;

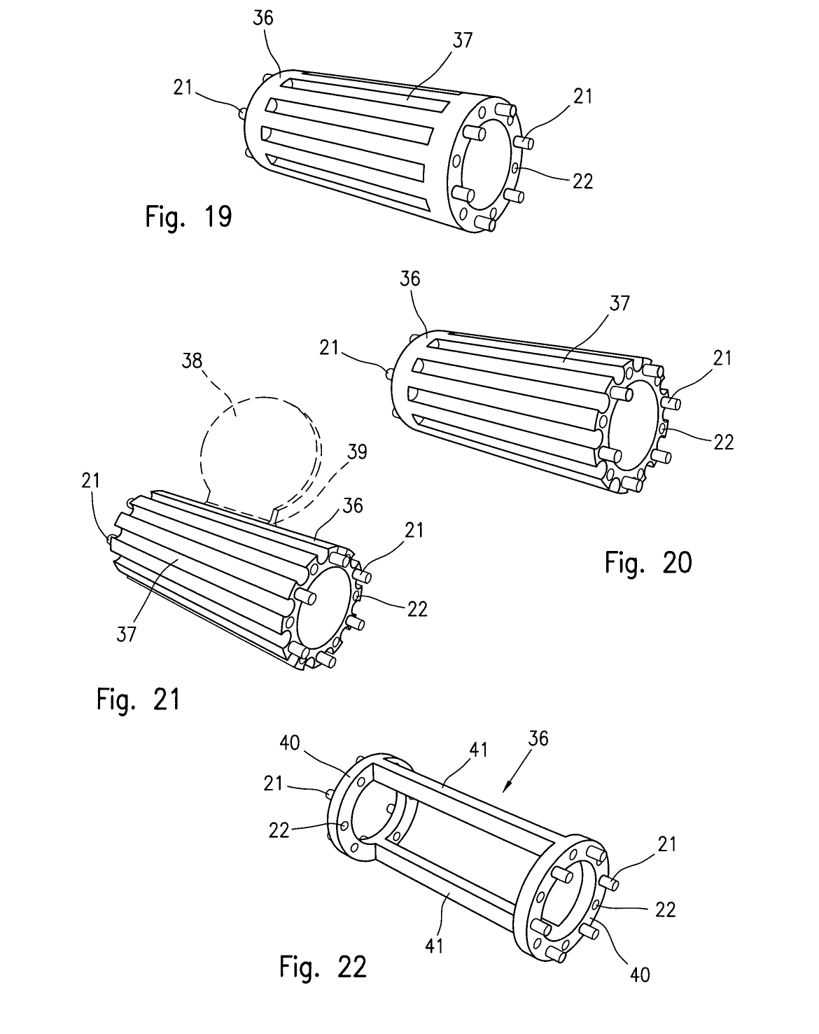

FIG. 19 shows a perspective view of a first embodiment of the intermediate connector;

FIG. 20 shows a perspective view of a second embodiment of the intermediate connector;

FIG. 21 shows a perspective view of a third embodiment of the intermediate connector;

FIG. 22 shows a fourth embodiment of the intermediate connector;

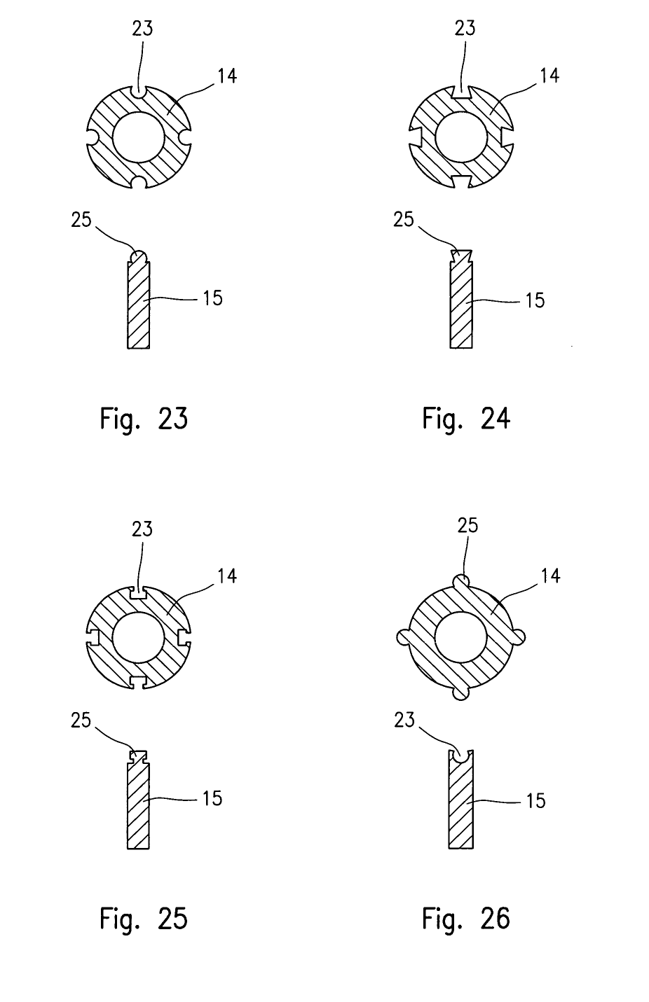

FIGS. 23 to 26 show some possible embodiments of the engaging means, between connecting elements and linking elements;

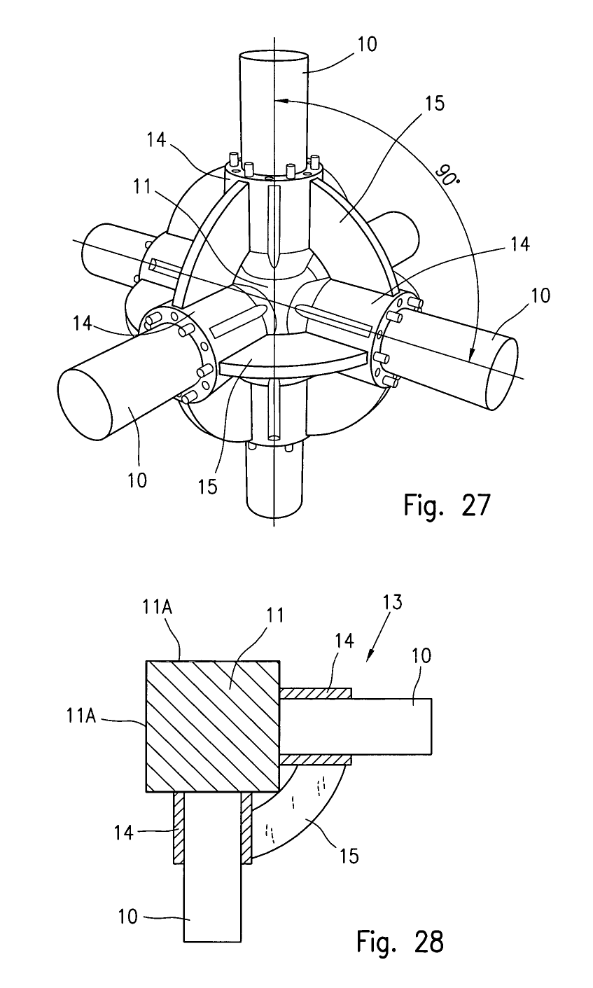

FIG. 27 shows the possibility of creating a three-dimensional joining system, by several angular joining devices of FIG. 4;

FIG. 28 shows a view similar to that of FIG. 12, in which the intermediate modular element has flat side surfaces;

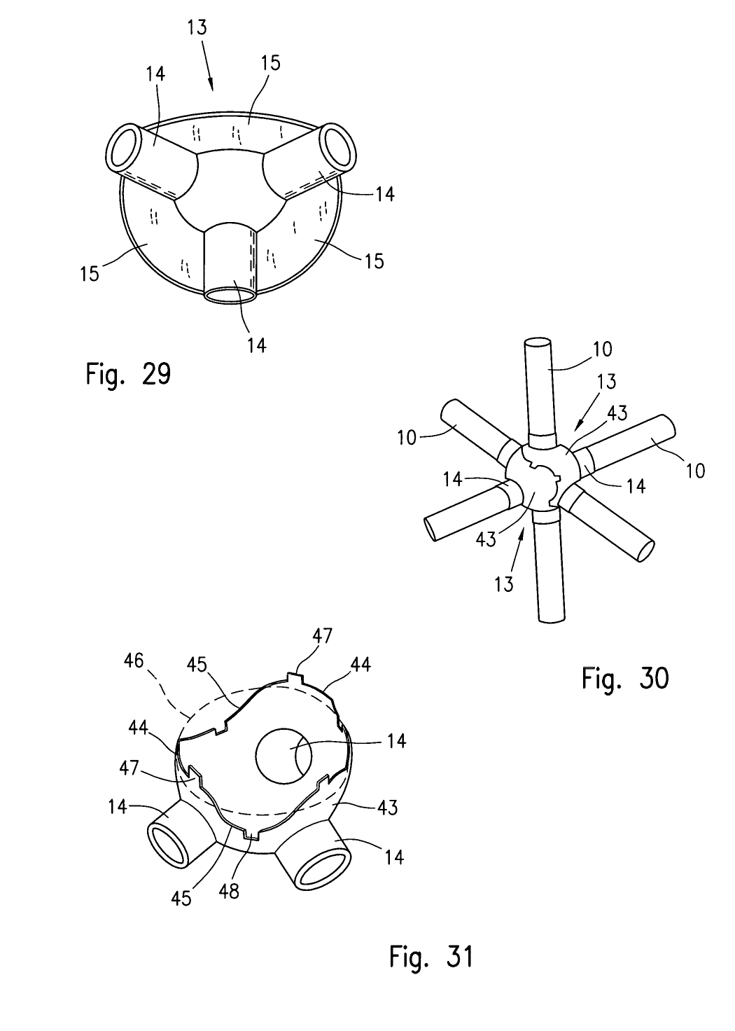

FIG. 29 shows a view of a further embodiment of an angular joining device according to the invention, comprising three connecting elements, having differently oriented longitudinal axes;

FIG. 30 shows a view of a junction knot for a reticulated structure, in which use is made of two joining devices according to a further embodiment;

FIG. 31 shows an enlarged perspective view of the joining device of FIG. 30;

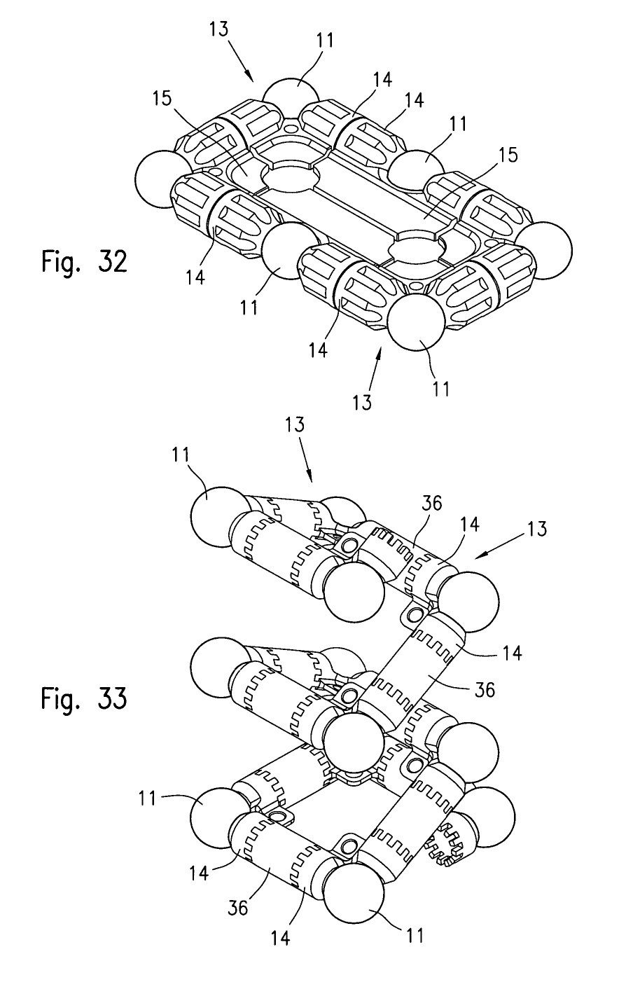

FIG. 32 shows a first assembly achievable by the use of joining devices according to the invention;

FIG. 33 shows a second assembly achievable by the use of joining devices according to the invention;

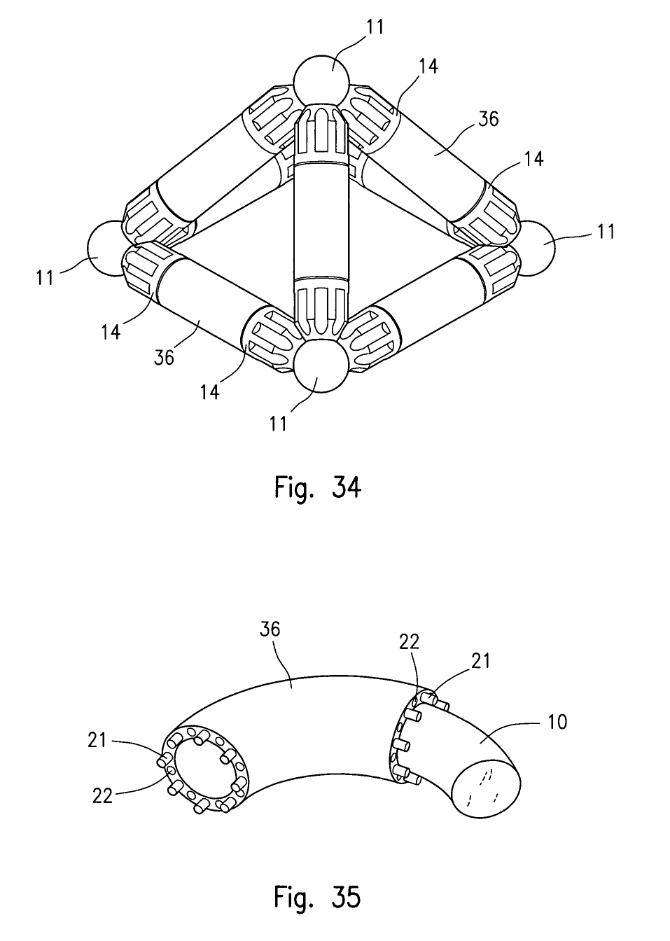

FIG. 34 shows a third assembly achievable by the use of joining devices according to the invention;

FIG. 35 shows an arch-shaped magnetic module, and an arch-shaped connector;

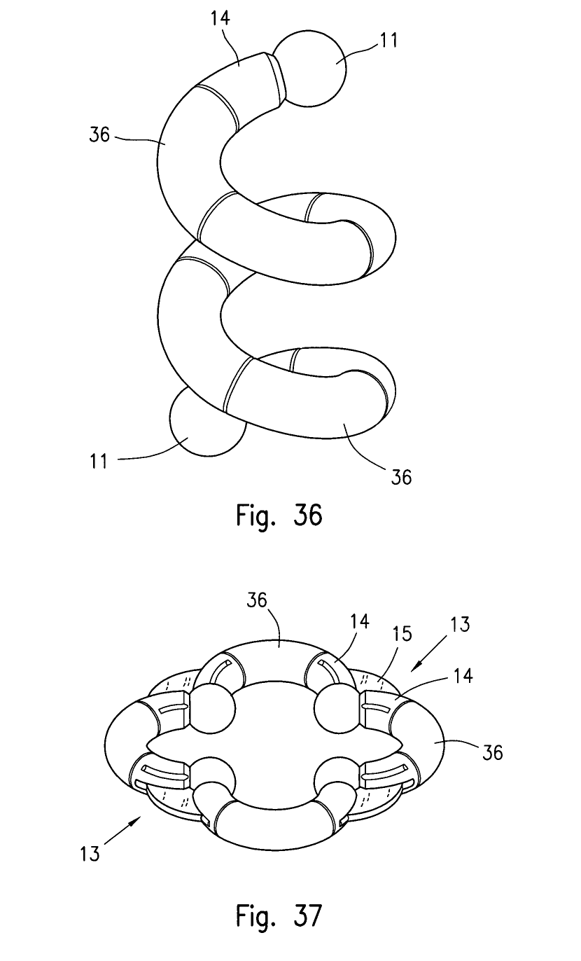

FIG. 36 shows an assembly achievable with arch-shaped magnetic modules and connectors of FIG. 35;

FIG. 37 shows a further assembly achievable with joining devices and arch-shaped connector, according to the invention.

### DETAILED DESCRIPTION OF THE INVENTION

With reference to the FIGS. 1 and 2, a description will now be given of the general features of an angular joining device and system according to the invention.

FIG. 1 shows part of an assembly consisting of three elongated magnetic modules 10.1, 10.2, 10.3, hereinafter more simply referred to as “bar”, in which said elongated modules or bars are magnetically connected by intermediate modular elements 11.1 and 11.2 consisting for example of spherical or ball-shaped elements of ferromagnetic material.

As shown, the longitudinal axes A and B of the bars 10.1 and 10.2 form between them an angle α for example of 90°; likewise, the axes B and C of the bars 10.2 and 10.3 form an angle of 90° between them, while the axis C forms an angle β, for example of 30° with respect to a reference plane defined by the axes A and B; however the aforesaid angles β and β could also differ from those indicated above.

From FIG. 1, it is evident that in the absence of suitable connecting means, the bars 10.1, 10.2, 10.3 and the intermediate modular elements 11.1 and 11.2, simply anchored magnetically, would not provide a structurally stable and rigid assembly, due to the possibility for the bars 10 to be subjected to relative pivotal and/or rotational movements tending to vary the angles α and β under the action of external forces or, in the case of complex assemblies of considerable dimensions, under the effect of their own weight.

Therefore, according to a first feature of the invention, use has been made of angular joining devices 13, conformed with axially interengageable retaining means, to prevent any pivotal and/or rotational movement between the joining devices and the bar-shaped elements 10.1, 10.2 and 10.3 with respect to the angles α and β.

According to the example of FIGS. 1, 2 and 3, in compliance with a first embodiment of the invention, the angular joining device 13 comprises a first and a second connecting member 14 spaced apart by an angle of 90° and a linking element 15 mould in plastic material in one piece with the connecting elements 14, as shown.

According to the example of FIGS. 1, 2 and 3, each connecting element 14 is in the form of a hollow section or hollow cylindrical body having a through hole 16 which extends between a rear end 17 facing the intermediate element 11 of the assembly, and a fore end 18, opposite the first one.

The hole 16 of the connector 14 defines an open seat or passage for the insertion of a bar-shaped element 10, in which the hole 16 is provided with an inner engaging surface 19 which conforms to an outer engaging surface of the elongated bars 10.

In the example shown, the engaging surfaces both of the bars 10, and of the connecting member 14 are cylindrical in shape; however, shapes differing from those shown cannot be excluded.

In the example under consideration, the axial hole 16 extends with a same diameter between the two ends 17 and 18 of the connector in element 14. Moreover, the latter, in correspondence with its rear end 17 may have a conical outer surface 20; however, the external surface of the connecting members 14 can be entirely cylindrical or differently shaped, as will be specified further on.

The rear end 17 of the connecting members 14 can end with a flat annular, or differently shaped surface, to conform to the outer surface of the intermediate element 11. From the figures it can also be seen that each connecting member 14 at its fore end 18 is provided with anti-rotational retaining means, conformed and arranged to frontally or axially engage anti-rotational retaining means of an axially aligned connecting member 14 belonging to another joining device 13, in the construction of an assembly. The above is shown by way of example, for the connecting members 14.1 and 14.2 of the two joining devices 13, relating to the same bar-shaped element 10.2 which extends between the two intermediate modular elements 11.1 and 11.2.

As mentioned previously, the connecting members 14 of each joining device 13 are provided at their fore end with antirotational retaining means, axially engageable, either directly or by an intermediate connector element, with similar retaining means of a connecting member pertaining to another joining device 13, to prevent pivotal and/or rotational movements between the same connecting members and consequently between the bars 10, in an assembled condition of an assembly.

FIGS. 1, 2 show a first preferential embodiment of the retaining means for the connecting members 14.

As shown, the fore end 18 of the connecting member 14 is provided with a plurality of pins 21 and holes 22, which extend parallel to the longitudinal axis of the same connecting member 14. The pins 21 and the holes 22 have substantially a same diameter so that in the assembled condition of the joining devices, the pins 21 of a connecting member 14 can be fitted into the holes 22 of a facing connecting member 14 axially aligned with the first one, and threaded on a same bar 10.

It will therefore be evident that any pivotal or angular movement of the bar-shaped elements 10, in the direction of the angles α and β, is totally prevented both by the intermediate linking elements 15 for connecting members 14 of each joining device 13, and by the engagement of pins 21 and holes 22 of the axially aligned connecting members 14.

FIGS. 4, 5 and 6 show a second preferential embodiment of an angular joining device 13 according to the invention. The embodiment of FIG. 4 differs from the embodiment of FIG. 2 due to the fact that now the connecting members 14 and the intermediate linking element 15 are made as separate parts, and are provided with engageable and disengageable connecting means. Therefore, in the FIGS. 4, 5 and 6 the same reference numbers of FIGS. 1, 2 and 3 have been used for similar or equivalent parts.

From the aforesaid figures it also emerges that each connecting member 14 is provided, on its outer surface, with a plurality of longitudinal slots 23 angularly spaced apart from one another, which open out towards the rear end 17 of the connecting element 14, in particular towards the conical surface 20 in the case under consideration; the slots 23 extend along part of the connector body 14 and end at their fore end with a shoulder 24.

In turn, the intermediate linking element 15 is conformed in such a way as to releasably engage with the outer slots 23 of two or more connecting elements 14 which, in an assembled condition form a double or multiple angular joining device according to the invention.

According to the example of FIG. 4, the intermediate linking element 15 for the connecting members 14 is in the form of an arch-shaped flat arm, which extends for an angle of 90°; however, the angular extension of the arm 15 could be wider or narrower than 90°, or differently shaped compared to the one shown.

From the example of FIG. 4 it also emerges that the linking arm 15 is provided at each end with a key 25 which extends along its transversal edge; the key 25 is shaped in such a way as to engage with any one of the outer slots 23 of the connecting members 14, by a sliding movement from the rear open end of the slot.

Consequently, in the construction of any assembly comprising magnetically anchored bar-shaped modular elements 10 and intermediate modular elements 11, different types of angular joining devices 13 can be provided in relation to different requirements, by the use of two or more connecting members 14 and a suitable intermediate linking element 15, shaped for such purpose.

FIG. 7 shows the cross-sectional view of a connecting element 14 suitable both for the angular joining devices of FIG. 2, and in separate pieces according to the example of FIG. 4; therefore also in FIG. 7 the same reference numbers of the previous figures have been used to indicate similar or equivalent parts.

The connecting element 14 of FIG. 7 differs from the connecting element of the previous examples, due to the fact that has a C-shaped cross section in which the longitudinal hole 16 now defines a side open seat for the insertion of the bar elements 10 by snap-on engagement through the same open side 26.

FIGS. 8, 9 and 10 also show examples of connecting members 14 and of the relevant retaining means.

In all the figures, the connecting member 14 has a cylindrical outer surface and a cylindrical inner mating surface which extend along the entire length between the fore end 18 and the rear end 17; in FIG. 8, the antirotational retaining means have again been represented in the form of pins 21 and holes 22 alternately disposed circumferentially, as in the previous examples.

FIG. 9 again shows a cylindrical-shaped connecting member 14 like the example of FIG. 8; the connecting member 14 of FIG. 9 differs from that of FIG. 8 in that now the angular retaining means consist of a tooth formation, comprising a plurality of teeth 27 annularly arranged and axially extending from the fore end 18; the teeth 27 are delimited by flat lateral surfaces 28 which extend in radial planes; this solution, like the solution of FIG. 8, makes it possible to obtain a firm engagement between connecting elements 14 and a high degree of rigidity, as well as contribute towards preventing flexure between the same connecting members once they have been engaged.

FIG. 10 shows a third solution for a connecting member 14 again provided at its rear end 18 with a tooth formation, whose teeth 27 are delimited by slanted side surfaces 28; this solution facilitates any possible angular adjustment merely by rotation.

The connecting members 14 of FIGS. 8, 9 and 10 are devoid of external slots; however, if required, the connecting members of FIGS. 8, 9 and 10 could be provided with longitudinal slots 23 according to the example of FIG. 4.

FIG. 11 shows a diagram designed to explain the possibility of obtaining wide ranges of angular adjustments in the positioning of the bars 10 and connecting members 14 of the joining devices 13 during the construction of an assembly; this may be obtained by using suitable means, for example by providing each connecting member 14 with a double attachment system between the connecting members of a same joining device 13, comprising a set of slots 23 and anti-rotational retaining pins and holes 21, 22, for example of the type shown in FIG. 4.

By indicating with P1 the angular pitch between a pin 21 and an adjacent hole 22 and with P2 the angular pitch between two adjacent slots 23, it is obvious that by rotating more or less the connecting element 14 by one pitch P1, or a multiple of the same pitch, and by choosing any one of the slots 23, it is possible to obtain a wide range of positioning angles for one or more linking elements 15.

For example, as shown in FIG. 11, there are pins 21 and holes 22 with an angular pitch P1 of 30°, and slots 23 with an angular pitch P2 of 45°; consequently, starting from a reference position of the linking element 15, it is possible to obtain an angular positioning, adjustable by 15° or multiples of P1 and/or P2 over an entire angle of 360°.

FIGS. 12 and 13 are schematic representations of a simple assembly comprising two bar-shaped magnetic elements 10, a spherical ferromagnetic element 11 and an angular joining device 13, in which for the sake of simplicity, the antirotational retaining means have been omitted.

FIGS. 12 and 13 show the possibility of conforming the joining device 13, in such a way that the connecting members 14 are directly in contact with the intermediate element 11, or arranged in a backward position in the construction of an assembly, in relation to the shape and dimensions of the same connecting members 14 and of the intermediate linking elements 15.

FIG. 14 shows a further embodiment of the connecting member 14 in which the anti-rotational retaining means have again been omitted; as can be seen, the inner mating surface 19, in correspondence with the rear end, is provided with a shoulder 19′, for example of conical shape designed to form a stop for the bar 10 having a correspondingly conformed conical end surface, while nevertheless allowing the magnetic anchorage between opposite surfaces of the modular elements 10 and 11.

FIG. 15 shows a further embodiment of an angular joining device 13; also in the case of FIG. 15, the same reference numbers as the previous examples have been used to indicate similar or equivalent parts.

The solution of FIG. 15 differs from that of FIG. 4 in that now the linking element 15 consists of an “L”-shaped key, for example a metal rod whose arms 15A and 15B may be inserted into respective slots 23 of two connecting members 14. Also in this case the angle between the two arms 15A and 15B of the “L”-shaped key can be of any type, equal to, greater or smaller than 90°.

FIG. 16 shows a different embodiment of the linking element 15 capable of allowing an angular adjustment between the arms 15A and 15B, and consequently an adjustment of the angle between the longitudinal axes of the connecting members 14 pertaining to a same joining device 13.

In fact, the characteristic that distinguishes this solution consists in the possibility of continuously adjusting the angle between the two arms 15A and 15B. The two arms 15A and 15B are hinged in 30 at one of their ends, while at the opposite end they are connected by an adjustable stay bolt 31, comprising a first threaded element 32A hinged in 33 to the arm 15A, a second threaded element 32B hinged in 34 to the arm 15B, the element 32B having a screw thread of opposite direction to that of the threaded element 31, as per a threaded bushing 35. By rotating the bushing 35 in one direction or in the opposite direction according to the double arrow W, it is possible to change the length of the stay bolt and consequently to adjust the angle α between the two arms 15A and 15B; other solutions are obviously possible, for example by providing a toothed or friction type joint in correspondence with the hinge 30.

FIG. 17 schematically shows an assembly comprising three bar-shaped elements 10, magnetically anchored to two spherical elements 11, in a way substantially similar to the example of FIG. 1, in which use is made of two angular joining devices 13 axially engaged by suitable anti-rotational retaining means, not shown, in the way previously described; in this case the length of the two connecting members 14 threaded onto the intermediate bar 10, is substantially equivalent to half the length of the bar itself, in the disposition of the connecting elements 14 in contact with the spherical elements 11, according to the example shown, or shorter whenever the connecting members 14 are in a backward position as in the previous example of FIG. 13.

FIG. 18 shows a different solution in which two axially aligned connecting members 14 of the assembly are indirectly engaged each other by an intermediate connector in the form of a tubular element 36; the intermediate connector 36 is provided at both end with pins and holes, or more properly with anti-rotational retaining means identical to those of the previously explained connecting members 14.

The solution of FIG. 18 can be of advantage whenever use is made of two bars 10 magnetically anchored to each other, or a magnetic bar of greater length. Here too, the antirotational retaining means have not been represented in order to simplify the drawing.

FIGS. 19 to 22 show some of several possible solutions for the intermediate connector 36. According to the examples of FIGS. 19, 20 and 21 the intermediate connector 36 is in the form of a tubular element having pins 21 and holes 22 at both ends, or in their place, the anti-rotational retaining means according to the examples of FIGS. 9 and 10, or retaining means of different type suitable for the intended purpose.

The tubular element 36 can have a smooth external surface, or can be provided with longitudinal slot 37 in which during the construction of an assembly a possible additional element 38 can be inserted, for decorative or for other functional purposes, as shown by way of example in FIG. 21.

The three solutions differ from one another in that, in the solution of FIG. 19 the slots 37 are closed at both ends; in the case of FIG. 20 the slots 37 are open at one of their ends, while in the case of FIG. 21 the slots 37 are open at both ends.

FIG. 22 shows a fourth embodiment of the intermediate connector 36; in this case the connector 36 is in the form of a cylindrical cage comprising an annular member 40 at each end, connected by two or more longitudinal rods 41.

The two annular members 40, on the front side, are provided with pins 21 and holes 22 or with anti-rotational retaining elements shaped in a way similar to those of the previous cases.

FIGS. 23 to 26 show different possible shapes of the slots 23 and of the corresponding ribbings 25 which can have a semicircular, dovetail or T-shaped cross section, both for connecting members 14, and the tubular intermediate connectors 36.

FIG. 27 shows a perspective view of a complex joint or knot, which is part of a reticulated structure constructed by assembling a plurality of elongated modular elements, such as the magnetic bars 10, and intermediate ferromagnetic elements, such as a ball-shaped or spherical element 11, in a wholly usual way.

FIG. 27 also shows how all the magnetic bars 10 of the joint, can be further mechanically connected to one another in such a way as to prevent any angular and/or rotational movement by angular joining devices 13 of the type shown in FIG. 4.

FIG. 28 shows, also by way of example, a solution in which an angular joining device 13 according to the invention, is used in the construction of a magnetic assembly in which the modular bars 10 are magnetically anchored to a ferromagnetic element 11 delimited by flat lateral surfaces 11A.

FIG. 29 shows the solution of an angular joining device 13 comprising three connecting members 14, oriented according to three orthogonal axes, each of which is provided with respective anti-rotational retaining means (not shown), of the type previously described, joined by three intermediate linking elements 15, as shown.

FIG. 30 again shows a joint for a reticulated structure, or assembly in which use is made of two complementary angular joining devices 13, conformed and disposed to house and completely enclose a spherical element 11 for a magnetic anchorage to bar-shaped elongated modular elements 10.

In particular, as shown in the perspective view of FIG. 31, each joining device 13 comprises three connecting members 14 oriented according to three orthogonal axes, joined by a emi-spherical central portion 43 having an internal engaging surface conforming to the surface of a spherical anchoring element 11, non shown; again the anti-rotational retaining means of the connecting members 14 have been omitted.

The emi-spherical central portion 43 comprises convex-shaped edge sections 44, alternated with concave edge sections 45 of a shape complementary to the convex edge sections 44, which extend from opposite parts with respect to an equatorial reference line 46.

The convex edge sections 44 and the concave edge sections 45 are provided with reciprocal engaging elements in the form of tongues 47 and cavities 48.

FIGS. 32 to 37 show some of the infinite constructional assemblies obtainable by magnetically anchorable modular elements, and joining devices according to the invention.

FIG. 32 shows a first example of an assembly obtained by combining a plurality of elongated or bar-shaped magnetic modular elements 10, not shown in the figure, with a plurality of spherical-shaped ferromagnetic modular elements 11 and joining devices 13, disposed according to the sides of a rectangle. Reference number 14 has again been used to indicate the connecting members threaded onto the bar-shaped elements 10, while the reference number 15 has been used to indicate the linking element between connecting members 14 of the angular or linear joining devices 13.

FIG. 33 shows the construction of a helicoids assembly with square loops in which, in addition to the modular elements 10, not visible, and 11, and to the angular joining devices 13, use is also made of intermediate tubular connectors 36 between opposite connecting members 14, pertaining to different angular joining devices in the assembly.

FIG. 34 shows the example of an assembly in which use is made again of the connecting members 14 of FIG. 4, in this case devoid of intermediate linking elements 15, with the intermediate connector 36 engaged to the connecting members 14, as shown.

In the previous figures use has always been made of bar-shaped elements 10, connecting members 14 and intermediate connectors 36 of linear shape for the construction of an assembly; conversely, in the FIGS. 35, 36 and 37 use has been made of similar arch-shaped elements. Once again, in these figures the same reference numbers of the previous figures have been used to indicate similar or equivalent parts.

In particular, FIG. 35 shows an arch-shaped elongated or bar element 10, and a corresponding arch-shaped connector 36.

FIG. 36 shows a helicoid assembly constructed by assembling arch-shaped elements of FIG. 35, while FIG. 37 shows a lobe-shaped assembly.

From what has been described and shown in the accompanying drawings, it will be clear that according to a first feature of the invention a joining device has been provided, capable of preventing relative movements between magnetic modular elements that make up an assembly, ensuring a highly stable structure, capable of withstanding internal and/or external stresses which would tend to deform the structure itself.

According to another feature of the invention a joining system comprising elongated-shaped modular magnetic elements, intermediate magnetic or ferro-magnetic elements for anchorage of the elongated magnetic elements, and angular and/or linear joining devices 13 composed of two or more connecting members 14 and/or connectors 36 is provided, in which the connecting members 14 have mating surfaces for engaging with mating surfaces of the elongated magnetic elements, being also provided with anti-rotational retaining means engageable directly or by intermediate connectors 36.

It is understood however that what has been described and shown has been given by way of example in order to illustrate the general characteristics of the joining device and system according to the invention and of its possible uses. Therefore other modifications or variations may be made to the entire joining device or parts thereof; for example the connecting members in addition to being disposed at an angle, can have their axes disposed parallel and/or slanting on one or more planes.

Moreover, a different use of the coupling devices can be contemplated in the construction of assemblies, without thereby departing from the accompanying claims.

1. A joining device suitable for a rigid connection between bar-shaped modular elements (10) having an outer mating surface, in which the bar-shaped elements (10) are magnetically anchorable each other to construct an assembly, the joining device (13) comprising:
at least a first and a second connecting member (14);
an intermediate linking member (15) between the connecting members (14);
each connecting member (14) having a hollow body defining an open passage for a bar-shaped element, said hollow body having an inner mating surface (19) which conforms to the outer mating surface of the bar-shaped elements (10), and extends between opposite open ends (17, 18);
wherein the hollow body of each of said connecting member (14) is provided, at one end, with antirotational retaining means comprising axially extending and angularly spaced apart retaining members (21, 22; 27), engageable with retaining members (21, 22; 27) of an axially aligned connecting member (14) of another joining device (13), both threaded on a same bar-shaped element (10) to prevent rotational movements between them.

2. The joining device according to claim 1, characterised in that the intermediate linking member (15) is integral with the connecting members (14) of the same joining device (13).

3. The joining device according to claim 1, characterised in that the linking member (15) and the connecting members (14) of the joining device (13) are conformed with engageable and disengageable connecting means (23, 25; 15A, 15B).

4. The joining device according to claim 1, characterised in that the connecting members (14) are arranged with an angular disposition with one another.

5. The joining device according to claim 1, characterised in that the connecting members (14) are parallely arranged to one another.

6. The joining device according to claim 1, characterised in that the connecting members (14) are axially aligned with one another.

7. The joining device according to claim 1, comprising a first, a second and at least a third connecting members (14), said connecting members (14) being arranged with different angular disposition.

8. The joining device according to claim 1, characterised in that the antirotational retaining means comprise a plurality of alternated pins and holes members (21, 22).

9. The joining device according to claim 1, characterised in that the antirotational retaining means comprise a tooth formation provided by a plurality of shaped teeth (27).

10. The joining device according to claim 9, characterised in that the teeth (27) have flat side surfaces (28) lying in radial planes.

11. The joining device according to claim 9, characterised in that the teeth (27) have slanted side surfaces (28).

12. The joining device according to claim 3, characterised in that the disengageable connecting means comprise a plurality of interengaging slots (23) and key members (25).

13. The joining device according to claim 3, characterised in that the connecting member (14) comprises a plurality of anti-rotational retaining members (21, 22; 27) spaced apart by a first angular pitch, and a plurality of disengageable connecting means (23) for the linking member (15), spaced apart by a second angular pitch.

14. The joining device according to claim 3, characterised in that the intermediate linking member (15) comprises first and second angularly arranged arms (15A, 15B).

15. The joining device according to claim 14, characterised in that said arms (15A, 15B) of the intermediate linking member (15) are pivotally connected each other (30), and adjustable locking means (31) for locking the arms (15A, 15B) of the linking member (15) in different angular positions.

16. The joining device according to claim 1, comprising a semispherical housing (43), said semi-spherical housing (43) having convex edge sections (44), alternated with complementary-shaped concave edge sections (45).

17. A joining system for a rigid connection between magnetically anchorable modular elements suitably for the construction of an assembly, comprising elongated modular elements (10) having an outer mating surface, and joining devices (13) to prevent pivotal and/or rotational movements between them, in which the joining system comprises:
at least a first and a second joining device (13) each provided with at least a first and a second connecting member (14), and an intermediate linking member (15);
each connecting member (14) having an hollow body defining an open passage therethrough for an elongated modular element (10), said hollow body having an inner mating surface (19) which conforms to the outer mating surface of the elongated modular elements (10), and extends between opposite open ends (17, 18);
wherein the hollow body of each connecting member (14) of each joining device (13) is provided at one end with antirotational retaining means comprising axially extending and angularly spaced apart retaining members (21, 22; 27) engageable with retaining members (21, 22; 27) pertaining to a connecting member of another joining device (13) both threaded on a same elongated modular member (10).

18. The joining system according to claim 17, characterised by comprising an intermediate connecting member (36) said intermediate connector member (36) being provided at both ends with antirotational retaining means (21, 22; 27) interengageable with antirotational retaining means (21, 22; 27) of axially aligned connecting members (14) of joining devices (13).

19. The joining system according to claim 18, characterised in that the intermediate connecting member (36) is in tubular form.

20. The joining system according to claim 19, characterised in that the intermediate connecting member (36) comprises a plurality of angularly spaced apart cavities (37) longitudinally extending on an external surface.

21. The joining system according to claim 18, characterised in that the intermediate connecting element (36) is in the form of a cage.

22. A magnetic assembly comprising:
a first set of bar-shaped modular elements (10), each having an external mating surface;
a second set of intermediate modular elements (11) magnetically anchorable to the bar-shaped modular elements (10); and
a third set of joining devices (13), said joining devices (13) being conformed and arrangeable each other to prevent angular and/or rotational movements between them and the bar-shaped modular elements (10) of the assembly;
wherein each joining device (13) is provided with at least a first and a second connecting member (14) having an hollow body provided with axially extending retaining means at one end; and
wherein the bar-shaped elements (10) and the connecting members (14) of the joining devices are conformed so that when each bar-shaped element (10) is inserted into the hollow body of respective first and second connecting members (14) of side by side arranged joining devices (13), each of said bar-shaped element (10) is held in magnetic contact with an intermediate modular element (11), and the retaining means (21, 22; 27) of the first connecting member (14), axially engage the retaining means (21, 22; 27) of the second connecting member (14), to hold the bar-shaped elements (10) of the assembly in a fixed relationship.
